(19) United States
(12) Patent Application Publication
(10) Pub. No.: US 2018/0136041 A1
(43) Pub. Date: May 17, 2018

(54) OPTICAL ANALYSIS SYSTEM WITH OPTICAL CONDUIT LIGHT DELIVERY

(71) Applicant: NEWPORT CORPORATION, Irvine, CA (US)

(72) Inventor: Jamie KNAPP, Mendon, MA (US)

(73) Assignee: NEWPORT CORPORATION, Irvine, CA (US)

(21) Appl. No.: 15/574,384

(22) PCT Filed: May 19, 2015
(86) PCT No.: PCT/US2015/031643

§ 371 Date: Nov. 15, 2017

(51) Int. Cl. G01J 3/02; G01J 3/28; G01J 3/36; G02B 6/293; G02B 27/10; G02B 27/14

(52) U.S. Cl. CPC G01J 3/0218; G01J 3/2803; G01J 3/0208; G01J 3/0229; G01N 21/645; G02B 6/2938; G02B 27/1006; G02B 27/141; G01J 3/36

(57) ABSTRACT

Optical analysis system and methods that may include a demultiplexing assembly with a photodetector array and a plurality of optical channels configured to prevent crosstalk therebetween. Some optical analysis system embodiments may include a multiplexer operatively coupled to a demultiplexing assembly may be used to split a single optical signal into multiple optical signals, or any other suitable purpose.

### RELATED PATENT APPLICATION(S)

This application is a national stage application under 35 U.S.C. section 371 of International Patent Application No. PCT/US2015/031643, filed May 19, 2015, naming Jamie Knapp as inventor, titled “OPTICAL ANALYSIS SYSTEM WITH OPTICAL CONDUIT LIGHT DELIVERY”, which is incorporated by reference herein in its entirety.

### BACKGROUND

Demultiplexing devices may be used for a wide range of applications where information is being derived from a light signal that may include one or more spectral components. Exemplary applications may include biomedical clinical chemistry analyzers, color-sorting instrumentation, atomic absorption spectrometry, etc. For such applications, it may be desirable to determine the intensity of a light signal at various wavelengths.

Some demultiplexing systems direct an incident light signal to a planar dichroic beam splitter which splits this light into two spectral signals. The reflected spectral signal may be directed through an optical filter and ultimately to a detector. The transmitted spectral signal may be transmitted through a dichroic beam splitter to a subsequent dichroic beam splitter which similarly repeats a spectral division of the incident light directing a portion of the signal to a detector while transmitting a portion of the incident light to subsequent dichroic beam splitters. The various dichroic beam splitters may be configured to reflect a discrete spectral portion of the incident signal. Each dichroic beam splitter/bandpass filter pair may be referred to as a “channel”. Each channel may have a dedicated optical sensor or photo sensor which may include a photodiode, a photomultiplier tube (PMT), or the like, which is used to analyze the incident light having a discrete wavelength or spectral band as determined by the dichroic beam splitter and bandpass filter. While these systems may offer some advantages over a filter wheel type system, they may not be suitable for some applications.

In addition, numerous demultiplexing configurations have been developed which use an optical grating in lieu of optical filters. These systems utilize light reflected from a diffraction grating to either discrete photodiodes, or alternatively, a compact linear diode array. While systems based on optical gratings may offer some advantages over filter-based systems, these also may not be suitable for some applications. For example, cost may be an issue for a grating based configuration. Expensive high quality gratings tend to work well in most applications, however, for applications requiring the lowest possible cost and simplicity, less expensive gratings tend to be of limited quality. In such cases, grating-to-grating repeatability may be poor and signal-to-noise and optical density (OD) may be less than ideal. Other shortcomings may include high sensitivity to optical alignment, mechanical complexity, and a high sensitivity to operating temperatures.

Demultiplexing systems that use sequential band pass reflectors to divide a single optical input signal into multiple spectra may also have some limitations when the respective wavelengths of the multiple spectra to be analyzed are closely spaced. This limitation may be caused by inherent limitations in the optical materials available for band pass reflectors or the like. In particular, the spectral behavior of a dichroic band pass reflector must be steep enough in order to keep each channel of the multiple spectra separate from each other. However, there are optical limitations to the steepness of such dichroic beam splitters due to polarization effects and other possible factors.

As such, existing multi-channel optical analyzers are useful, but do not address the needs of some applications. In general, what has been needed are optical demultiplexing systems that may be miniaturized, may be manufactured for a cost effective price, are able to maintain optical precision and reliability or any combination of thereof. What has also been needed are demultiplexing systems that are compact yet still configured to analyze optical signals with wavelengths that are closely spaced or overlapping. What have also been needed are optical demultiplexing systems that are compact yet capable of analyzing multiple optical signals from multiple respective optical signal sources.

### SUMMARY

Some embodiments of an optical analysis system may include a photo detector array. The photo detector array may include a plurality of adjacent detector elements with coplanar input surfaces. In some cases, each detector element may have a corresponding output interface such as a pair of electrical pins operatively coupled thereto. In other cases, two or more detector element may be coupled to each other and coupled to a common output interface such as a pair of electrical pins. The photo detector array may further include active portions and inactive portions. The optical analysis system may also include a demultiplexing assembly which may include a plurality of optical channels. Each optical channel may include a channel cavity which is bounded by lateral baffles. The lateral baffles may be configured to optically isolate each channel cavity from all of the other channel cavities of the demultiplexing assembly. Each channel cavity may also include an input end, and an output end which may be disposed such that it is opposite the input end and is adjacent to the photo detector array. The output end of each channel cavity may include an output aperture which may be in optical communication with a respective active portion of the photo detector array. Each optical channel may further include a bandpass filter which is disposed within the channel cavity. The bandpass filter may include an input surface which is disposed towards the input end of the channel cavity, and an output surface which is disposed towards the output end of the channel cavity. Each optical channel may also include an optical conduit. The optical conduit may include an output end which may be secured relative to the channel cavity such that a discharge axis of the optical conduit is directed into the channel cavity. The discharge axis of the optical conduit may further be directed towards the input surface of the bandpass filter and towards the output aperture of the channel cavity. In some cases, such an optical analysis system may also include an optional multiplexer that is operatively coupled to the demultiplexing assembly. The multiplexer may include a multiplexer housing and a lens cavity which is disposed within the multiplexer housing. The multiplexer may also include a plurality of multiplexer output channels which are in optical communication with optical conduits of respective optical channels of the demultiplexing assembly. The multiplexer may further include an input optical conduit which may have an output end which is secured relative to the lens cavity of the multiplexer housing such that an optical discharge axis of the input optical conduit is directed towards input surfaces of optical conduits of respective optical channels of the demultiplexing assembly. The multiplexer may also include a lens which is disposed within the lens cavity. The lens may be configured to direct an optical output of the input multiplexer optical conduit to each multiplexer output channel.

Certain embodiments are described further in the following description, examples, claims and drawings. These features of embodiments will become more apparent from the following detailed description when taken in conjunction with the accompanying exemplary drawings.

### BRIEF DESCRIPTION OF THE DRAWINGS

The drawings illustrate embodiments of the technology and are not limiting. For clarity and ease of illustration, the drawings may not be made to scale and, in some instances, various aspects may be shown exaggerated or enlarged to facilitate an understanding of particular embodiments.

FIG. 1 is a transmission vs. wavelength graph representing the outputs of multiple optical channels of a previous embodiment of an optical analysis system.

FIG. 2 is a schematic of a previous embodiment of an optical analysis system.

FIG. 3 is a transmission vs. wavelength graph representing the outputs of multiple optical channels of a previous embodiment of an optical analysis system.

FIG. 4 is an isometric view of an embodiment of an optical analysis system.

FIG. 5 is an isometric view of an embodiment of a demultiplexing assembly and a photo detector array.

FIG. 6 is a section view of the demultiplexing assembly of FIG. 5.

FIGS. 7 and 8 are elevation views of a baffle assembly.

FIG. 9 is an enlarged view of the encircled portion 9 of FIG. 6.

FIG. 10 is an elevation view of an optical conduit mounting block.

FIG. 11 is an isometric view of the demultiplexing assembly and photo detector array of FIG. 5, with the photo detector array being coupled to a circuit board.

FIGS. 12 and 13 are isometric views of photo detector array embodiments.

FIG. 14 is a top view of a silicon chip wafer photodetector.

FIG. 15 is a top view of a photo detector array embodiment showing detector elements which have been permanently grounded to make them inactive.

FIG. 16 is an enlarged view of the encircled portion 16 FIG. 6.

FIG. 17 is an isometric view of a multiplexer embodiment.

FIG. 18 is a section view of the multiplexer embodiment of FIG. 17 taken along lines 18-18 in FIG. 17.

FIG. 19 is an isometric view of a multiplexer embodiment.

FIG. 20 is a section view of the multiplexer embodiment of FIG. 19 taken along lines 20-20 of FIG. 19.

FIG. 21 is an isometric view of an embodiment of an optical analysis system including a demultiplexing assembly.

FIG. 22 is a section view of the demultiplexing assembly of FIG. 21.

FIG. 23 is a transmission vs. wavelength graph representing graphically the net optical filter/detector responsivity of an embodiment of a demultiplexing assembly and photo detector array.

### DETAILED DESCRIPTION

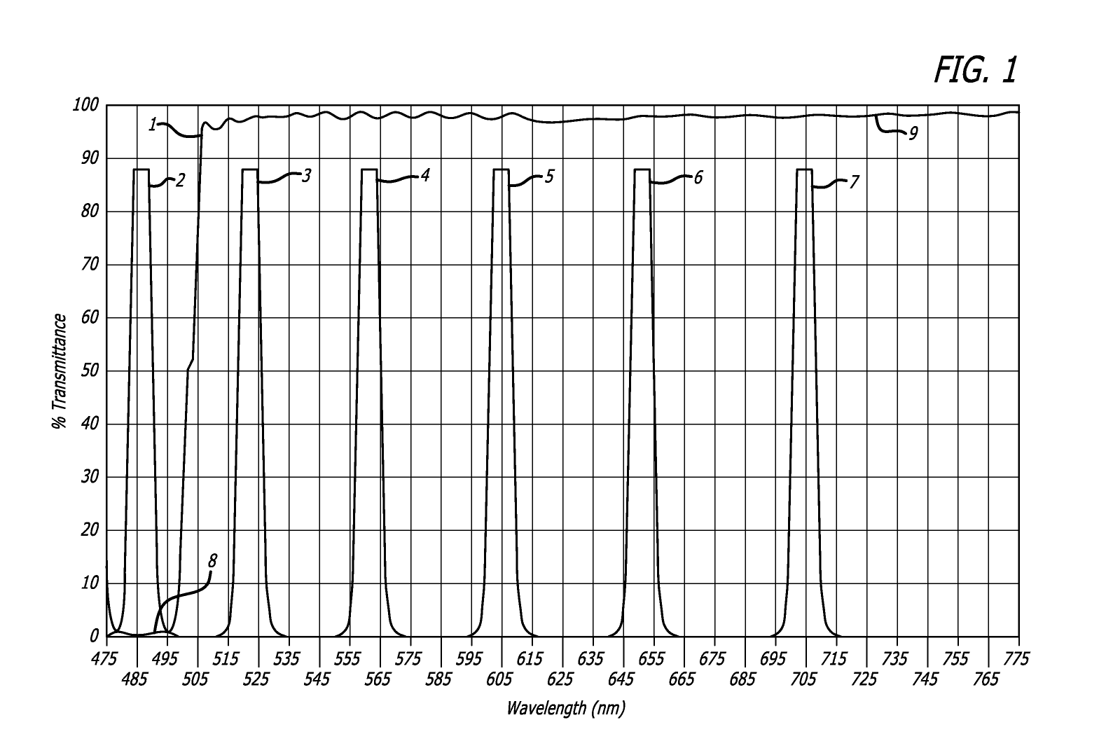

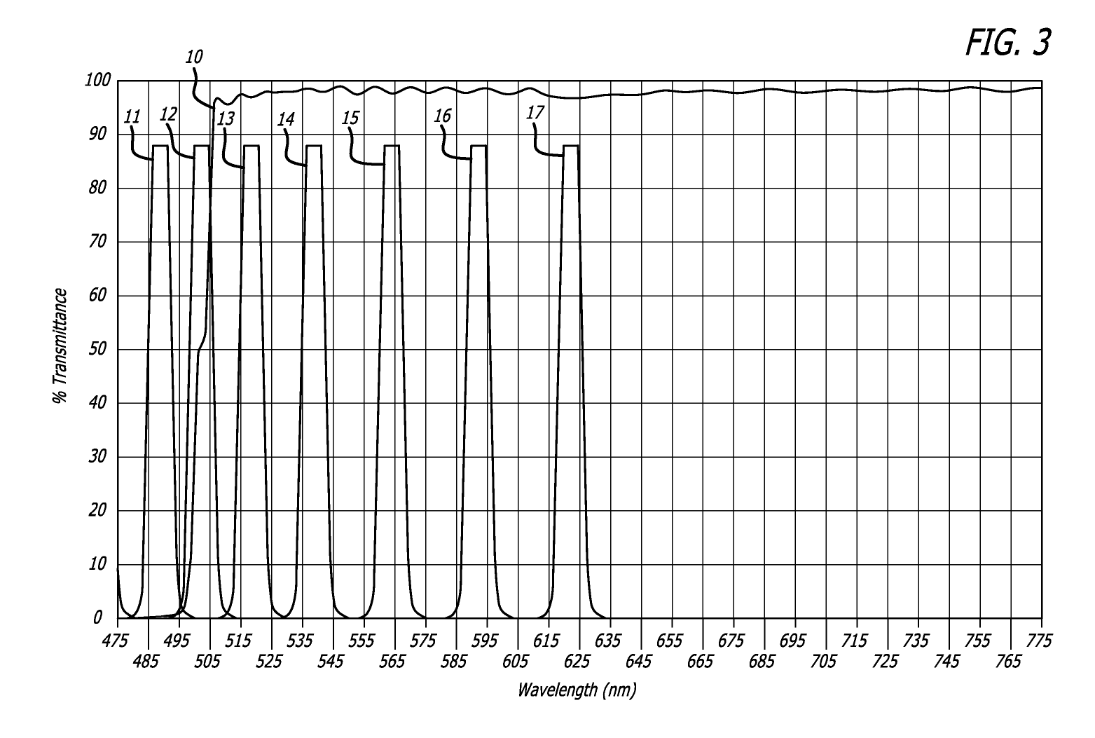

Optical analysis systems may be used for a number of critical instrument applications including biomedical fluorescence applications, industrial measurement and control applications, environmental contamination applications and the like. In general optical analysis systems may be used in order to determine the spectral properties of an optical signal. The optical analysis system may be configured to measure the intensity of the optical signal within a single wavelength bandwidth, or the optical analysis system may be configured to measure multiple intensities of multiple wavelength bandwidths of the optical signal. In some cases optical analysis systems may be used in order to determine the composition of a sample material by analyzing the spectral properties of optical signals which have been passed through or reflected from the sample material. The intensity of the optical signals within an optical wavelength band can indicate the amount of a given substance within the sample material (or the absence of a given substance within the sample material). The optical analysis systems may utilize optical channels in order to separate optical signals into separate wavelength bands for analysis. The use of optical conduits such as optical fibers for guiding optical signals to each respective optical channel can have significant benefits for an optical analysis system which includes them. FIGS. 1 and 3 are graphs which depict percentage of transmission versus wavelength for two optical analysis systems. The graphs of FIGS. 1 and 3 are used in order to illustrate the advantage of utilizing optical conduits such as optical fibers in optical analysis systems.

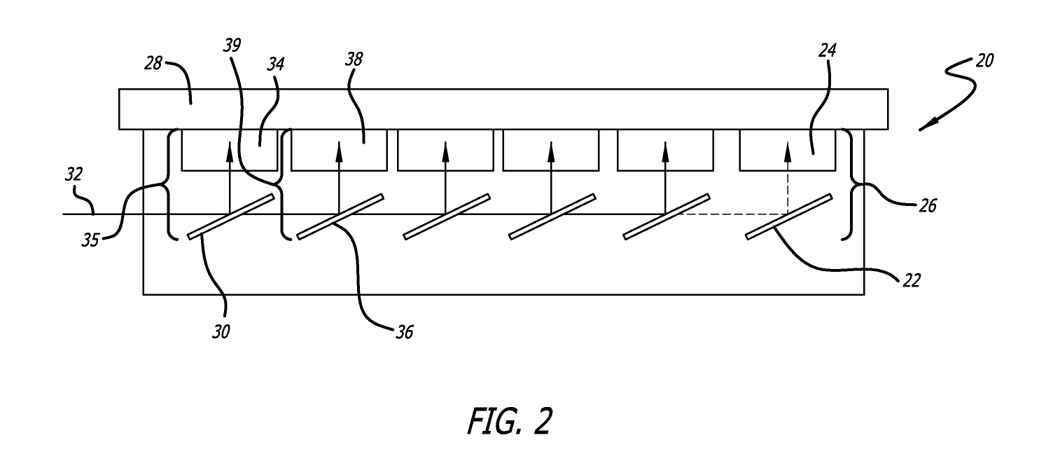

FIG. 1 is a graph displaying optical transmission versus wavelength data for an embodiment of an optical analysis system 20 (configured as a demultiplexer) which is shown in a schematic representation in FIG. 2. The optical analysis system 20 of FIG. 2 may include multiple dichroic beamsplitters 22 and multiple bandpass filters 24. Each dichroic beamsplitter 22 may be optically coupled to a respective bandpass filter 24, with each dichroic beamsplitter 22 and respective bandpass filter 24 forming an optical channel 26 of the optical analysis system 20 as shown in FIG. 2. The optical analysis system 20 of

FIG. 2 may also include a photo detector array 28. A first dichroic beamsplitter 30 may be disposed within the optical analysis system 20 such that it positioned at 45 degrees with respect to an input optical signal 32 which is incident to the optical analysis system 20. A datum curve 1 which is depicted in FIG. 1 represents the percentage of the input optical signal 32 which is transmitted through the first dichroic beamsplitter 30 as a function of the wavelength of the input optical signal 32. Portions of the input optical signal 32 which are substantially below a first cutoff wavelength (in this case about 490 nm as an example) of the first dichroic beamsplitter 30 may be reflected by the first dichroic beamsplitter 30 and may thus have a nominal percentage of transmission through the first dichroic beamsplitter 30 as is indicated by wavelength datum region 8 of datum curve 1 in FIG. 1. Portions of the input optical signal 32 which are substantially above the first cutoff wavelength are transmitted through the first dichroic beamsplitter 30 as indicated by wavelength datum region 9 of datum curve 1.

The first dichroic beamsplitter 36 thus functions to reflect portions of the input optical signal 32 which are within the wavelength datum region 8 of datum curve 1 and to transmit portions of the input optical signal 32 which are of longer wavelengths and are within wavelength datum region 9 of datum curve 1. The distinction between portions of the input optical signal 32 which are reflected or transmitted are determined by first cutoff wavelength of the first dichroic beamsplitter 30. Portions of the input optical signal 32 which are reflected by the first dichroic beamsplitter 30 (as represented in wavelength datum region 8) may be directed through a first bandpass filter 34. The optical intensity of and optical information contained within the portion of the input optical signal 32 which is transmitted through the first bandpass filter 34 may be measured by an active portion of the photo detector array 28 which is in optical communication with the reflected output of the first dichroic beamsplitter 30. The percentage transmission of the portion of the input optical signal 32 which is transmitted through the first bandpass filter 34 is represented by datum curve 2 in FIG. 1, which can be considered the output of a first optical channel 35 which is formed by the first dichroic beamsplitter 30 and the first bandpass filter.

Portions of the input optical signal 32 which are above the first cutoff wavelength of the first dichroic beamsplitter 30 may be transmitted through the first dichroic beamsplitter 30 and directed toward a second dichroic beamsplitter 36. The second dichroic beamsplitter 36 may be configured with a suitable second cutoff wavelength. Portions of the input optical signal 32 which are directed toward the second dichroic beamsplitter 36 and which have wavelengths which are less than the second cutoff wavelength may be reflected by the second dichroic beamsplitter 36 and transmitted through a second bandpass filter 38. Portions of the input optical signal 32 which are transmitted through the second bandpass filter 38 may propagate to the photo detector array 28 which can be used to measure the optical intensity of the signal. The percent transmission of the optical signal which passes through the second bandpass filter 38 is represented by datum curve 3 in FIG. 1, which can be considered the output of a second optical channel 39 which is formed by the second dichroic beamsplitter 36 and the second bandpass filter 38. Portions of the incident optical signal 32 which are above the cutoff frequency of the second dichroic beamsplitter 36 may be transmitted through the second dichroic beamsplitter 36 and directed towards additional optical channels which are formed by subsequent dichroic beamsplitters and respective bandpass filters. Datum curve 4 of FIG. 1 represents the output of a third optical channel, datum curve 5 represents the output of a fourth optical channel and so on for datum curve 6 and datum curve 7.

It may be important that the spectral behavior of the first dichroic beamsplitter 30 (or any beamsplitter disposed within the optical analysis system) is steep (see the slope of datum curve 1 in FIG. 1) in order to efficiently separate the optical outputs of the various optical channels thereby minimizing the optical crosstalk between optical channels.

Optical crosstalk can occur when portions of the input optical signal 32 which are within a spectral bandwidth which is intended to be directed toward the first optical channel 35 (that is optical signals which are within the wavelength bandwidth of a first optical channel) instead propagate into the second optical channel 39 (or vice versa). The optical crosstalk effect is illustrated in FIG. 3 which is a graph displaying optical transmission versus wavelength for another embodiment of an optical analysis system (not shown) having multiple optical channels. In this case, the spectral separation between the output of a first optical channel (as represented by datum curve 11 depicted in FIG. 3) and the output of a second optical channel (as indicated by datum curve 12 depicted in FIG. 3) is insufficient to be properly split-apart by the dichroic beamsplitter (the output of which is depicted by datum curve 10 in FIG. 3) of the optical analysis system. The result is excessive cross-talk between the output of the first optical channel and the output of the second optical channel as indicated in FIG. 3. The spectral separations between the outputs of the other optical channels which are depicted in FIG. 3 (as represented by datum curves 13, 14, 15, 16, and 17) are also insufficient to prevent crosstalk between the respective channels of the optical analysis system.

For such a system, wavelength spacings in between discrete optical channels should be spectrally spaced far enough away from each other to allow the dichroic beamsplitters to efficiently spectrally separate the optical channels. For some applications, the required wavelength spacings of such a system are adequate. FIG. 1 illustrates this, where datum curve 1 indicates a typical transmission versus wavelength spectral behavior of the first optical channel's 35 first dichroic beamsplitter 30 (which is physically positioned at 45 degrees with respect to the incident optical signal). This first dichroic beamsplitter 30 reflects a portion of the incident optical signal 32 of a narrow spectral band (as indicated by wavelength datum region 8 in FIG. 1), and transmits the remaining portion of the incident optical signal 32 (as indicated by wavelength datum region 9 in FIG. 1). The narrow spectral band of light is directed through the first bandpass filter 34 (at normal incidence), and is subsequently detected by the photo detector array 28. Those wavelength bands of additional channels (second, third, etc.) are transmitted through the first dichroic beamsplitter 30. It is desirable that the spectral behavior of the first dichroic beamsplitter 30 be sufficiently steep (that is the slope of datum curve 1 in FIG. 1 be sufficiently steep) in order to efficiently separate the first optical channel 35 and the second optical channel 39.

However, there may be performance limitations to the steepness of a dichroic beamsplitter due to polarization effects etc. For those cases where the wavelength separation between channels is too close together (see datum curve 11 and datum curve 12 both depicted in FIG. 3), the use of dichroic beamsplitters may not be practical. For these and other applications, embodiments discussed herein solve the problem by replacing the dichroic beamsplitters with separate optical conduits (such as optical fibers) for each optical channel which illuminate each optical channel individually. There are applications, such as fluorescence analysis, where it may be desired that each discrete channel is of the same wavelength within the entire demultiplexing system; each channel may be used to analyze light of a common wavelength bandwidth coming from different biological samples for example. Also in these cases, the use of fibers to direct light into each channel of a demultiplexer embodiment may have significant benefits over the use of dichroic beamsplitters.

An embodiment of an optical analysis system 40 that utilizes optical conduits 42 such as optical fibers in order to isolate optical signal portions 46 (see FIG. 16) of an input optical signal 44 for a demultiplexing assembly 52 is depicted in FIG. 4. The optical analysis system 40 may be configured to determine the optical intensities of multiple wavelength bandwidths of an input optical signal 44 of single wavelength bandwidth. In some cases the input optical signal 44 may be separated into discrete optical signal portions 46 by a variety of ways, such as by the multiplexer 50 embodiment disposed between the sample 48 and the demultiplexing assembly 52 of the optical analysis system 40. In some cases, the input optical signal may be channeled from the sample to the multiplexer 50 by an input multiplexer optical conduit 43. Each optical signal portion 46 propagating from the multiplexer 50 may then be guided to the demultiplexing assembly 52 and optically modified such that the wavelength spectrum of each optical signal portion 46 is contained within a desired wavelength bandwidth. Optical modification of some or all of the optical signal portions 46 may include optical filtering of some or all of the optical signal portions 46 to produce filtered signal portions 47 (see FIG. 16).

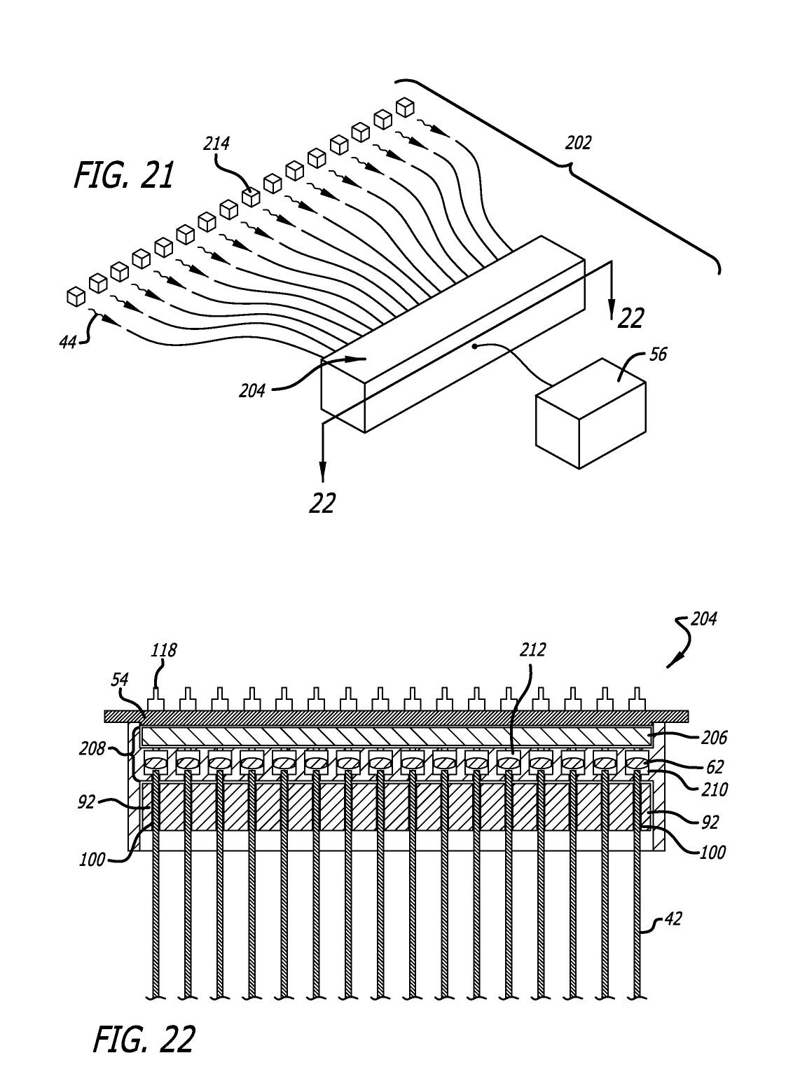

For the optical analysis system 40 embodiment which is shown in FIG. 4 the input optical signal 44 emanating from the sample 48 is split into multiple optical signal portions 46, with each optical signal portion 46 including the same or substantially the same optical spectrum i.e. the same optical data. This arrangement differs from the optical analysis system 202 embodiment shown in FIG. 21 wherein each optical channel 208 (see FIG. 22) of the demultiplexing assembly 204 embodiment shown receives an input optical signal 44 through a distinct optical conduit 42 from a distinct and separate sample material 214. Of course, optical analysis system embodiments that combine the system embodiment of FIG. 4 and the system embodiment of FIG. 21 are also contemplated herein.

For example, an optical analysis system embodiment may include a single demultiplexing assembly embodiment with one or more channels that are coupled to distinct samples 214 corresponding to each such optical channel 208 as shown in the embodiment of FIG. 21. The same demultiplexing assembly embodiment may also include multiple other channels operatively coupled to a single sample material 48 such as by the multiplexer embodiment 50 shown in FIG. 4. It should be noted that an optical analysis system embodiment that may provide a similar configuration and result to that shown in FIG. 4 might be achieved by having the input end 45 of each optical conduit 42 of each respective optical channel of the demultiplexing assembly 52 shown in FIG. 4 in direct optical communication with the input optical signal 44 of the sample 48 shown in FIG. 4 without the use of the interrupting multiplexer 50. For such an arrangement (not shown) it may be useful to bundle or otherwise gather multiple input ends 45 of the respective optical conduits 42 such that the input ends 45 are in close proximity to each other and receive similar input optical signal 44 data and intensities.

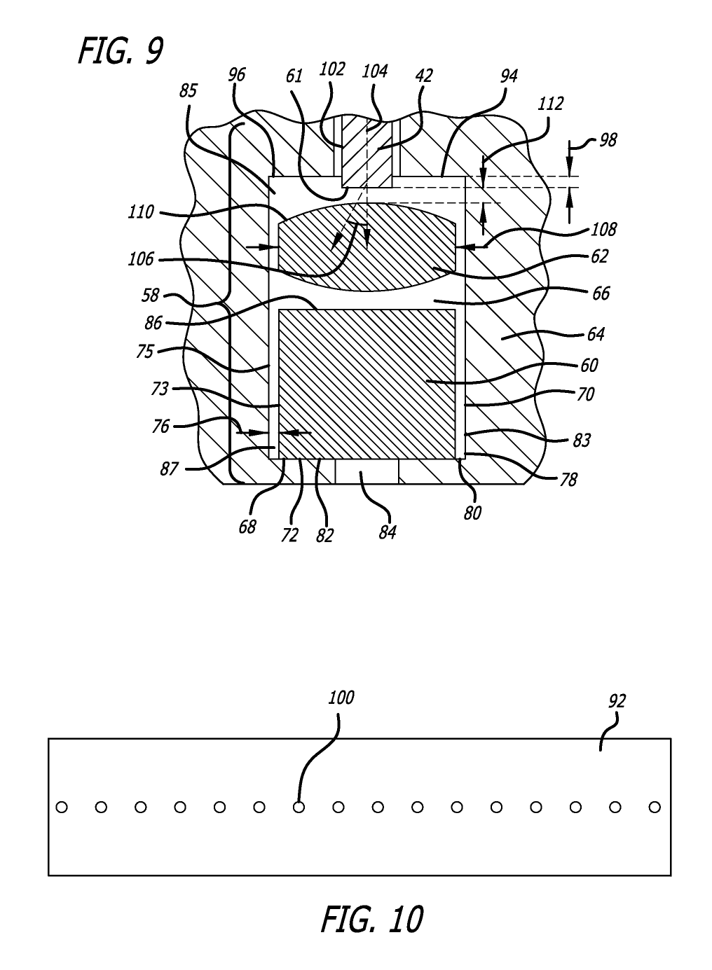

Referring again to the embodiment of FIG. 4, the optical intensity of each filtered signal portion 47 can be measured such as by a photo detector array 54 (see FIG. 12) and may be analyzed by an analyzer 56 in order to characterize the input optical signal 44. Once each optical signal portion 46 has been optically modified (such as by filtering) to have a desired wavelength bandwidth, each filtered signal portion 47 carries optical intensity information (such as spectral information for example) for the wavelength bandwidth of the respective optical channel 58 (see FIG. 9) of the filtered signal portion 47. Thus it may be important that the optical signal portions 46 remain optically isolated from each other within their respective optical channels 58 in order to avoid optical crosstalk between the optical signal portions 46.

The analysis performed by the analyzer 56 which is optically coupled to the demultiplexing assembly 52 may include biomedical chemistry chemical analysis, color sorting, instrumentation analysis, atomic absorption spectroscopy analysis or any other suitable optical analysis. In some cases, the input optical signal 44 may be analyzed by the optical analysis system 40 in order to determine the spectral properties of the input optical signal 44. When it is required by the type of analysis being performed, the input optical signal 44 may be transmitted through or reflected from a sample material 48 in order to determine properties of the sample material 48 based upon the spectral properties of the transmitted optical signal.

In some cases, the optical analysis system 40 may include the multiplexer 50 that may be used to separate the input optical signal 44 into multiple optical signal portions 46. The optical analysis system 40 may also include multiple optical conduits 42, the demultiplexing assembly 52, the photo detector array 54, and the analyzer 56. The multiplexer 50 may be configured to split the input optical signal 44 into a plurality of optical signal portions 46. Each optical signal portion 46 may then propagate through an optical conduit 42 of a respective optical channel 58 and be emitted from an output end 102 of the optical conduit 42 into a channel cavity 66 (see FIG. 9) of the demultiplexing assembly 52. Each optical channel 58 may be configured to optically modify the optical signal portions 46 such that each optical signal portion 46 is contained within a distinct wavelength bandwidth. The respective intensities of each distinct optical signal portion 46 may then be measured as an optical channel output by an active portion of the photo detector array 54. Optical information from each optical channel output may then be processed by a processor of the analyzer 56 in order to determine the spectral properties (or any other desired information) of the input optical signal 44. The analyzer 56 may be configured to analyze or otherwise manipulate the data from each optical channel 58. In order to manipulate the data from each optical channel 58, the analyzer 56 may include a data input interface (not shown), the processor (not shown), a data storage member (not shown), and a visual display device (not shown) or the like. The optical conduits 42 of each optical channel 58 may be used in order to transmit each optical signal portion 46 from the multiplexer 50 to a respective optical channel 58 of the demultiplexing assembly 52. Each optical signal portion 46 may be substantially contained within a respective optical conduit 42 during transmission of the optical signal portion 46 from the multiplexer 50 to the demultiplexing assembly 52, so the optical conduits 42 act to optically isolate each optical signal portion 46.

In order for the analyzer 56 to properly process the spectral data of the input optical signal 44 which is being analyzed by the optical analysis system 40, it may be very important that the optical crosstalk between the optical channels 58 of the demultiplexing assembly 52 be minimized or eliminated. The optical crosstalk between optical channels 58 can be minimized through the use of physical baffles disposed within the demultiplexing assembly 52 which optically isolate each optical channel 58 from all other optical channels 58. In addition active portions of the photo detector array 54 which measures the output of each optical channel 58 may be electrically isolated from each other by grounding of inactive portions of the photo detector array 54 there-between. The use of the optical conduits 42 for each of the optical channels 58 further facilitates the isolation of the optical channels 58.

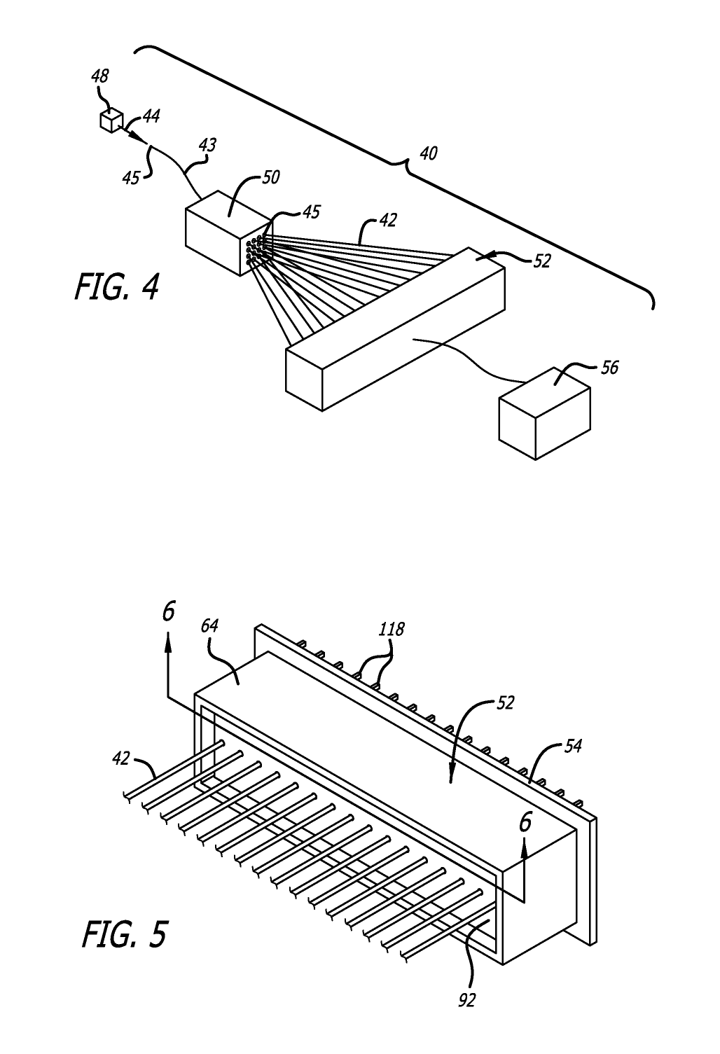

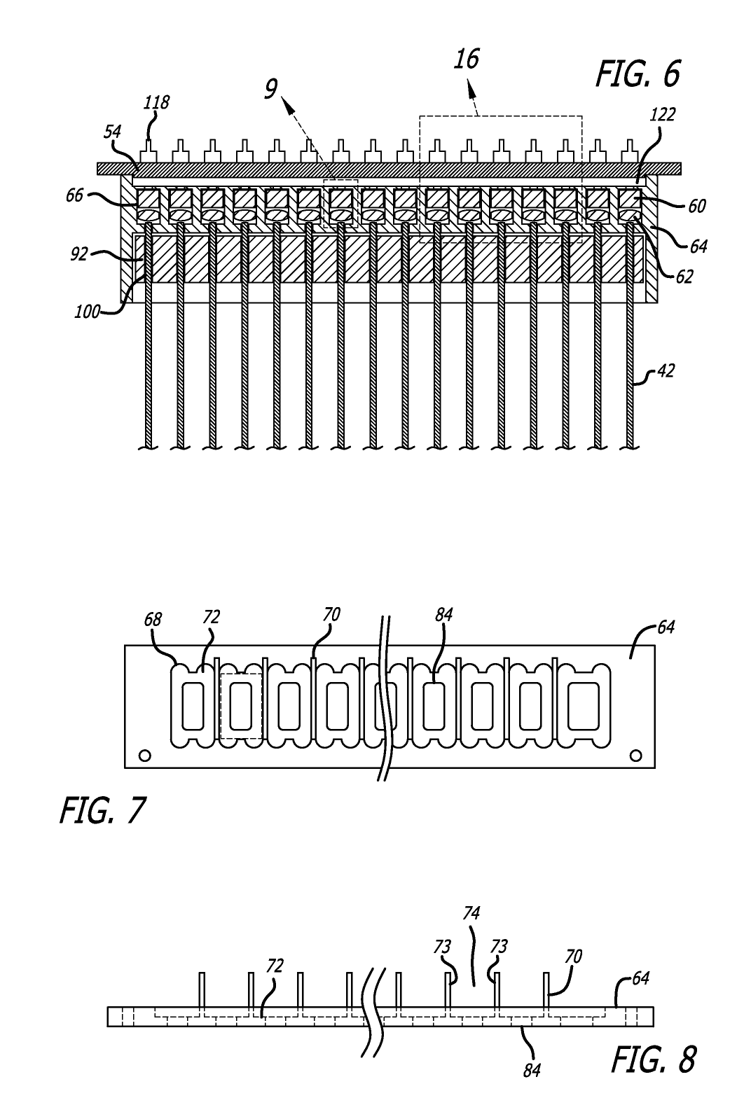

As has been discussed previously, elements of the optical analysis system 40 including the demultiplexing assembly 52 may be configured to minimize optical crosstalk between optical signal portions 46 propagating within the optical channels 58. FIG. 5 is an exterior view of an embodiment of a demultiplexing assembly 52 (including multiple optical conduits 42) which is secured to a photo detector array 54. A cross section of the demultiplexing assembly 52 and photo detector array 54 is shown in FIG. 6. The demultiplexing assembly 52 may include a plurality of optically isolated optical channels 58, with each optical channel 58 optionally being configured to modify the spectral bandwidth (by reducing the spectrum of the optical signal to a specified wavelength bandwidth) of an optical signal portion 46 which passes through the respective optical channel 58. The demultiplexing assembly 52 embodiment which is shown in FIG. 9 includes 16 optical channels 58, however, such demultiplexing assembly 52 embodiments may include any suitable number of optical channels 58. Some demultiplexing assembly 52 embodiments may have about 2 to about 50 optical channels 58, more specifically about 5 optical channels 58 to about 25 optical channels 58, and even more specifically about 8 optical channels 58 to about 20 optical channels 58. Each optical channel 58 which is disposed within the demultiplexing assembly 52 may be configured to minimize optical crosstalk between the optical channels 58 as will be discussed below.

An optical channel 58 embodiment of the demultiplexing assembly 52 is shown in cross-section view in FIG. 9. Each optical channel 58 may include an optical conduit 42 which is configured to guide and confine the propagation of an optical signal portion 46 and which functions to optically isolate and to direct an optical signal portion 46 which is transmitted by the optical conduit 42. Each optical channel 58 may also include a bandpass filter 60 which functions to alter the spectral bandwidth of an optical signal portion which passes through the bandpass filter 60. Each optical channel 58 may include an optional collimating lens 62 which may serve to focus an optical signal portion 46 which exits an output surface 61 of an optical conduit 42 into a respective bandpass filter 60. The demultiplexing assembly 52 may include a channel housing 64 which may be secured in fixed relation to the photo detector array 54. Each optical channel 58 may also include a channel cavity 66 which is disposed within the channel housing 64, with each channel cavity 66 being optionally configured with multiple baffles which may function to optically isolate each optical channel 58 from adjacent optical channels.

The multiple baffles of each optical channel 58 may serve to prevent or reduce measurement error of the optical analysis system 40. For example, each channel cavity 66 may include one or more support baffles 68 and one or more lateral baffles 70 each of which are depicted in FIGS. 7, 8, and 9. The channel housing 64 embodiment which is shown in FIGS. 7 and 8 may be configured for 16 optical channels 58, however, such channel housing 64 embodiments may be configured for any suitable number of optical channels 58. The support baffles 68 may include a support surface 72 which is configured to engage and support a corresponding or matched bandpass filter 60. The support baffles 68 may be configured to reduce or eliminate optical “bleed-by”, whereby optical information from an optical signal portion 46 travels around an outside lateral edge 73 of a bandpass filter which could then introduce an unfiltered spectrum to the photo detector array 54 and be measured by the photo detector array 54 and significantly introduce measurement error. The lateral baffles 70 shown in FIGS. 7 and 8 may be positioned between the bandpass filters 60. As such, the lateral baffles 70 may serve to optically isolate the bandpass filter 60 regions from scattered, misdirected, or unwanted light from neighboring optical channels 58, thereby improving measurement accuracy.

Each channel cavity 66 may be laterally bounded by the lateral baffles 70 as shown in FIG. 6. The lateral baffles 70 are configured to optically isolate each channel cavity 66 from all of the other channel cavities, in that the materials of the channel housing 64 which form the lateral baffles 70 may be any suitably opaque material that does not allow for transmission of optical information such as Matt black anodized aluminum or the like. The lateral baffles 70 may be positioned between the optical bandpass filters 60 such that they are disposed in a gap 74 formed between the lateral sides 73 of optical bandpass filters 60 which are adjacent each other. In some cases, the lateral baffles 70 may be in contact with the lateral sides 73 of the bandpass filters, in other embodiments, there may be a gap 76 between an outer surface 75 of the lateral baffle and an outside edge 73 of the adjacent bandpass filter 60. The lateral baffles 70 may be manufactured from any variety of materials in a variety of configurations so long as they provide a barrier disposed between adjacent bandpass filter 60 elements that a light signal cannot pass through. As shown in FIGS. 7 and 8, the lateral baffles 70 may be configured to have a continuous structure with respect to the support baffles 68. In some instances, a bottom edge 78 of the lateral baffles 70 may be disposed on or continuous with a top surface 80 of a corresponding adjacent support baffle 68 such that no gap exists there between and no portion of a light signal may pass between the lateral baffle 70 and support baffle 68.

Each support baffle 68 may be disposed such that it is over at least part of an output surface 82 of each respective bandpass filter 60. The support baffles 68 may include the support surface 72 which is configured to provide a ledge disposed about a bottom portion 83 of each channel cavity 66 and engage and support the bandpass filters 60. As such, in some cases, the output surface 82 of the bandpass filter 60 may be in contact with the support surface 72 of the corresponding support baffle 68 as shown in FIG. 9. The support baffles 68 may also include an output aperture 84. The output aperture 84 may be formed within the support baffle 68. Each support baffle 68 may serve to further optically isolate its respective optical channel 58 by preventing optical signals from the optical channel 58 from being transmitted to other optical channels. Each channel cavity 66 may also include an input end 85 and an output end 87 which are disposed at opposite ends of the channel cavity 66. For the embodiment shown, the output surface 61 of the optical conduit is disposed at the input end 85 of the channel cavity 66. The output end 87 of the channel cavity 66 may include the output aperture 84 which may be in optical communication with a respective active portion of the photo detector array 54.

For some embodiments, the support baffles 68 and associated lateral baffles 70 for each optical channel 58 may be formed from a unitary monolithic structure. The channel housing 64 which is disposed around the channel cavity 66 and the associated baffle structures may act to seal each channel cavity 66 from airborne contamination such as dust as well as optical contaminates. In some cases, the entire baffle assembly may be in the form of a continuous monolithic structure that includes lateral baffles 70, support baffles 68, and the output aperture 84 all of which are formed from a single piece of material. In some cases, such an assembly may be machined from a single piece of aluminum or other suitable high strength material. The lateral baffles 70 may also extend vertically above an input surface 86 of the adjacent corresponding bandpass filter 60 so as to prevent transmission of light that is reflected or scattered from one bandpass filter 50 to adjacent optical channels 58.

The bandpass filters 60 of the demultiplexing assembly 52 may be configured to alter the optical properties of an optical signal portion 46 which is transmitted through the bandpass filter 60 by reducing or otherwise narrowing the spectrum of the optical signal portion 46 to a specified wavelength bandwidth thereby creating a filtered signal portion 47. Each bandpass filter 60 may be configured to transmit an optical signal within a selected wavelength range. Each bandpass filter 60 may include the input surface 86 which is disposed toward the input end 85 of the channel cavity, and each bandpass filter may include the output surface 82 which is disposed toward the output end 87 (and output aperture 84) of the channel cavity 66.

In some cases the bandpass filters 60 may be manufactured with a cost-effective laminated construction, consisting of absorptive color glasses or dyes, along with transparent glasses having deposited onto them various multilayer optical interference coatings. It is noted that the size of the bandpass filter 60 and associated output aperture 84 of the support baffle 68 may be selected depending upon the photo detector array 54 responsivity at the wavelength bandwidth of the bandpass filter 60. For example a large bandpass filter 60 and associated output aperture 84 may be used for a wavelength bandwidth where the photo detector array 54 has low responsivity. A larger bandpass filter 60 allows more light to illuminate the underlying area of the photo detector array 54, which may result in improved signal to noise ratio.

For some embodiments of the demultiplexing assembly 52 each bandpass filter 60 may be configured to pass a predefined narrow spectral band of light as may be needed for a desired application. For example, a first bandpass filter 88 (see FIG. 16) may be configured to transmit light having a wavelength band centered at about 340 nm, while a second adjacent bandpass filter 90 may be configured to transmit light having a wavelength band center at about 380 nm. As such, a series of optical bandpass filters may be configured to individually transmit light having wavelength bands centered at about 340 nm, 380 nm, 405 nm, 510 nm, 546 nm, 578 nm, 620 nm, 630 nm, 670 nm, 700 nm or 800 nm therethrough for some embodiments. Embodiments of such a demultiplexing assembly 52 and any others discussed below may include the optical channel wavelengths discussed above, but may also include any appropriate number of channels which may be configured to pass any desired spectral bandwidth centered at any desired wavelength, depending on the particular application.

The bandpass filters 60 may be configured to transmit a predetermined wavelength range or band of the optical signal portion 46. The bandpass filters 60 may be manufactured with a cost-effective laminated construction, consisting of absorptive color glasses or dyes, along with transparent glasses having deposited onto them various multilayer optical interference coatings. Standard 10 mm diameter optical filters of this type have good optical performance (typically >70% transmission) and cost about $15 each. For some biomedical and measurement/control applications though, optical detection in the shorter ultraviolet (U.V.) wavelength band, for example, in an optical band having a wavelength of about 230 nm to about 320 nm, may be desired. In this U.V. light wavelength range, such standard low-cost laminated optical filters may not be suitable due to optical absorption by the laminating epoxies and the lack of color glasses and dyes within this wavelength range. Rather, such filters for use in the ultraviolet spectrum are typically produced with air-gap metal-dielectric-metal (MDM) type designs. Such MDM filters are typically free from optically absorbing epoxies and, as such, offer improved lifetimes and performance over epoxy-based designs when exposed to ultraviolet light.

Each optical signal portion 46 which exits the multiplexer 50 may enter an optical channel 56 of the demultiplexing assembly 52 of FIG. 5 through an optical conduit 42. An output surface 61 of each individual optical conduit 42 may be disposed in fixed relation to its respective channel cavity 66 via a conduit mounting block 92 which is shown in FIG. 10.

The conduit mounting block 92 may be disposed at the input end 85 of the channel cavities 66 of the demultiplexing assembly 52, and the conduit mounting block 92 may be configured to secure the optical conduits 42 in a fixed relation to the channel cavities 66 and associated channel structures such as the bandpass filters 60. As shown in FIG. 9, the output surface 61 of each optical conduit 42 may extend into the input boundary 94 of the input end 85 of the channel cavity 66, with the input boundary 94 of the input end 85 of the channel cavity 66 being defined by a plane formed by the input edges 96 of the lateral baffles at the input end 85 of the channel cavity 66. The output surface 61 of each optical conduit 42 may extend past the input boundary 94 of the input end 85 of each respective channel cavity 66 by a distance 98 of about 0.5 mm to about 5 mm in some cases (see FIG. 9).

The conduit mounting block 92 may be configured with conduit channels 100 of an appropriate diameter to hold output ends 102 of the optical conduits 42 securely in place. Each optical conduit 42 may be secured to a respective conduit channel 100 of the conduit mounting block 92 by any suitable adhesive such as Epo-Tec OH105-2 or similar epoxy. The conduit mounting block 92 may be secured to the channel housing 64 such that a discharge axis 104 of each optical conduit 42 is directed into the respective channel cavity 66 towards the respective input surface 86 of the respective bandpass filter 60 and towards the respective output aperture 84 of the respective support baffle 68. Further, an output surface 61 of each optical conduit 42 may be directed toward and in optical communication with an input surface 86 of the bandpass filter 60 and the output aperture 84 of the channel cavity 66. Embodiments of the optical conduits 42 may be any suitable optical waveguide such as an optical fiber including but not limited to silica core/silica clad optical fibers. The optical fiber may be configured as a multimode optical fiber, and may have a transverse core diameter of about 100 microns to about 1000 microns. The silica core and/or silica cladding of the optical fiber may be suitably doped in order to ensure substantial internal reflection of an optical signal within the optical fiber. Dopants may include GeO₂, P₂O₅, B₂O₃, TiO₂, AlO₃ or the like. Additionally, plastic material may be used in order to form the core and/or the cladding of the optical fiber. For some embodiments, the numerical aperture of the optical fibers may be between about 0.12 and about 0.22.

Some of the optical signal portion 46 may diverge as it exits the output surface 61 of the optical conduit 42 as shown in FIG. 9. If the numerical aperture of the optical fiber is too high portions of the optical signal portion 46 may be cut off by the lateral baffles 70 prior to the optical signal portion 46 reaching the input surface 86 of the bandpass filter 60. This may result in a loss of intensity and/or optical information of the optical signal portion 46 thereby decreasing the measurement accuracy of the optical analysis system 40. As such, because the optical signal portion 46 may diverge as it exits the optical conduit 42, an optional collimating lens 62 may be disposed along the discharge axis 104 of the optical conduit 42, and on the input side of the input surface 86 of the respective bandpass filter 60. The purpose of the collimating lens 62 being to direct the divergent optical signal portion 46 which exits the output surface 61 of the optical conduit 42 towards the input surface 86 of the bandpass filter 60 and the output aperture 84 of the support baffle 68 of the channel cavity 66. Each collimating lens 62 may be fabricated from any suitable material such as fused silica or the like. Additionally each collimating lens 62 may be coated with optical coatings such as MgF2 or other dielectric AR coating. For some embodiments, the focal length of the collimating lenses 62 may be from about 3 mm to about 20 mm.

During use of the demultiplexing assembly 52 each optical signal portion 46 may be guided within a respective optical conduit 42, and may then exit an output surface 61 of the optical conduit 42 along a discharge axis 104 of the optical conduit 42 and into the channel cavity 66. Each optical signal portion 46 may diverge as it exits the respective optical conduit 42 along the discharge axis 104, with the divergence angle 106 of the optical signal portion 40 being dependent upon the numerical aperture of the optical conduit 42. In some cases, each optical signal portion 46 upon being emitted from an output surface 61 of a respective optical conduit 42 expands within a three dimensional volume thereby forming a solid angle, with the solid angle being determined by the divergence angle 106 of each optical signal portion 46. For some embodiments of the demultiplexing assembly 52, each optical signal portion 46 which is propagating within each solid angle which is emitted from each optical conduit 42 may overlap and encompass each input surface 86 of a bandpass filter 60 of a respective optical channel 58. For other embodiments of the demultiplexing assembly 52, each optical signal portion 46 which is propagating within each solid angle which is emitted from each optical conduit 42 may overlap and encompass an input surface 110 of a respective optional collimating lens 62. The numerical aperture of the optical conduit 42 which may determine the divergence angle 106 of the optical signal portion 46, the diameter 108 and focal length of the associated collimating lens 62, and a distance 112 between the output surface 61 of the optical conduit 42 and an input surface 110 of the associated collimating lens 62 may all be configured such that a divergent optical signal portion 46 which exits the optical conduit 42 is entirely captured by the input surface 110 of the collimating lens 62. As an example, the numerical aperture of the optical conduit 42 may be about 0.22 which gives a divergence angle 106 of about 13 degrees as measured from the discharge axis 104. If the diameter 108 of the collimating lens 62 is 4 mm, the focal length of the collimating lens 62 is about 3 mm to about 5 mm, and the distance 112 between the output surface 61 of the optical conduit 42 and the input surface 110 of the collimating lens 62 is about 2 mm then most all of the optical signal portion 46 which exits the output surface 61 of the optical conduit 42 may be captured by the collimating lens 62, passed through the respective bandpass filter 60 which transforms the optical signal portion 46 into a filtered signal portion 47. The filtered signal portion 47 may then be passed through the output aperture 84 of the respective support baffle 68 and then strike the associated active surface of the photo detector array 54 which can then measure the optical intensity of the filtered signal portion 47.

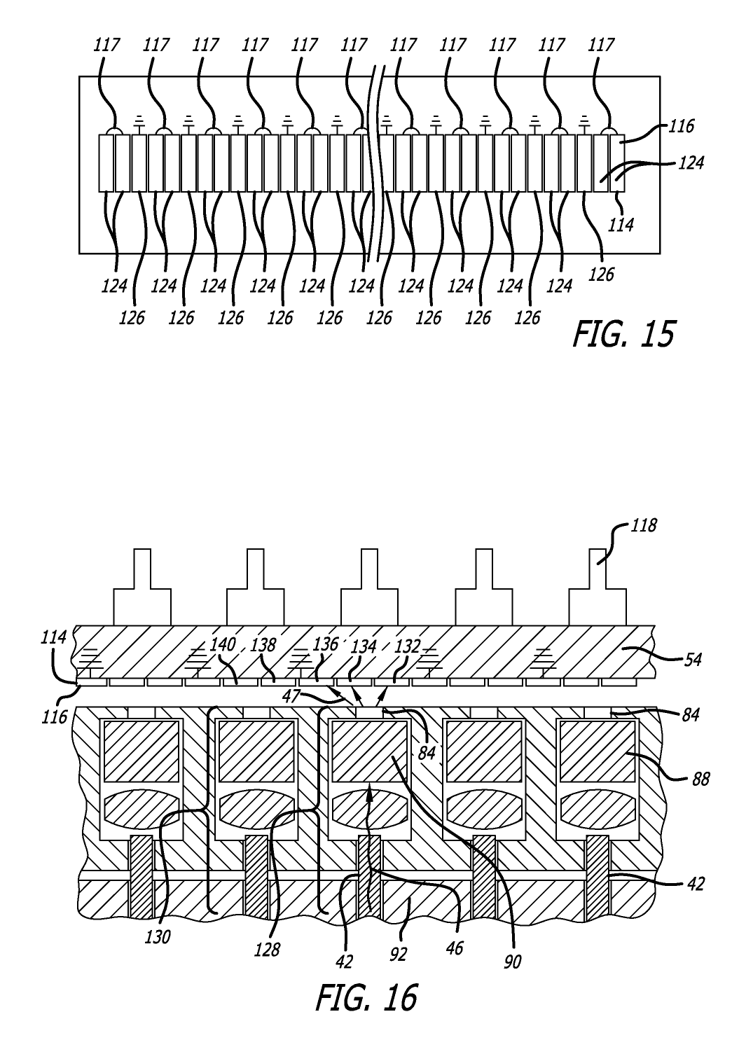

The photo detector array 54 which is shown in FIGS. 12-15 may include a plurality of adjacent detector elements 114. The detector elements 114 may have coplanar input surfaces 116 which may be disposed adjacent the output aperture 84 of associated support baffles 68. An output interface of each optical channel 58 may include one or more electrical pins 118 which are in electrical communication or operatively coupled with at least one detector element 114. Demultiplexer embodiments which are discussed herein may have any suitable number of output interfaces as required by the configuration of the respective photo detector array. In some cases each detector element 114 may be coupled to a pair of electrical pins 118 to serve as an output interface. In other cases, two or more detector elements may be operatively coupled to the same pair of electrical pins 118. For example, in some instances, two or more adjacent active detector elements 124 may be electrically coupled together by an electrical jumper 117 as shown in FIG. 15. Electrically coupling the active detector elements 124 may serve to effectively create a single detector element larger than the individual detector elements 114. For such embodiments, a single pair of electrical pins 118 may be operatively coupled to two or more detector elements 114 as shown in FIGS. 15 and 16 and serve as the output interface for the coupled detector elements 124.

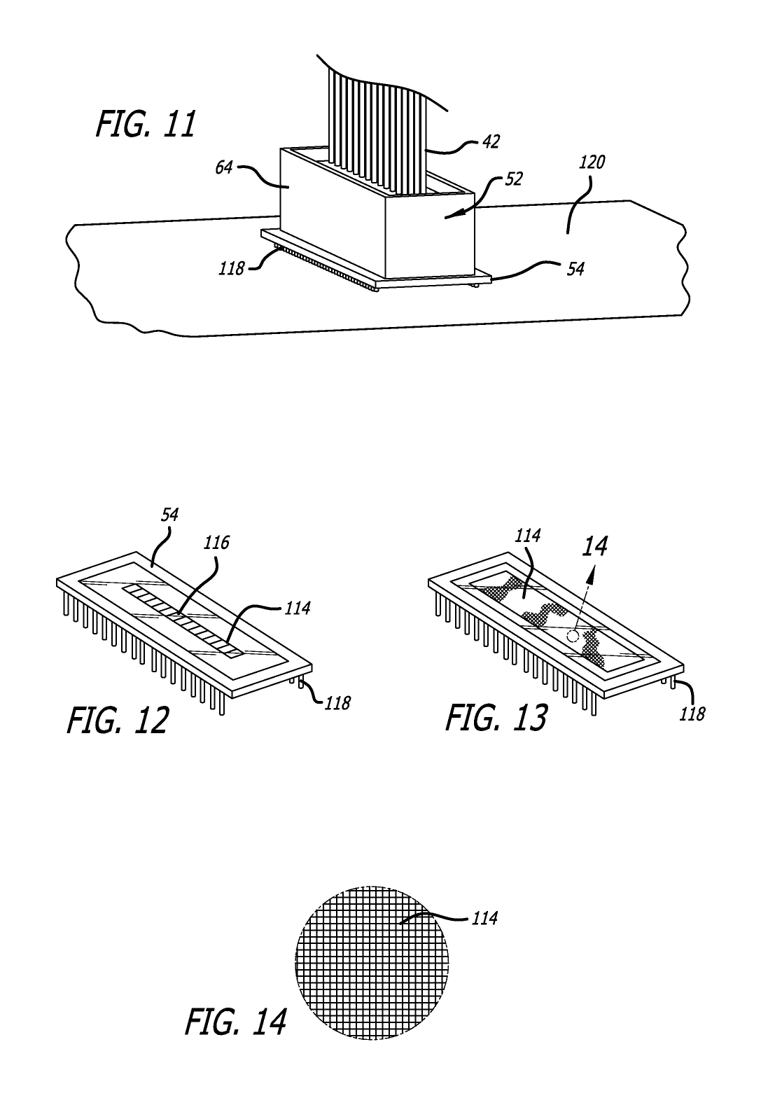

The analyzer 56 may be operatively coupled to the electrical pins 118 of each detector element 114 of the photo detector array 54, with the analyzer 56 being configured to receive and store optical intensity data from active portions of the photo detector array 54. FIG. 11 depicts the demultiplexing assembly 52 secured to a circuit board 120 which may in turn be electrically coupled to the analyzer 56. The detector elements 114 may be arranged such that they form a linear array as shown in FIG. 15. In some cases the detector elements 114 may be fabricated from silicon, SiC, InSb, InGaAs, HgCdTe, Ge, PbS or other semiconductor materials depending upon the desired detection wavelengths.

The demultiplexing assembly 52 may be secured to the photo detector array 54 such that each optical channel 58 and specifically the output aperture 84 of each support baffle 68 of each channel cavity 66 is disposed adjacent to the appropriate detector elements 114. In some cases, the demultiplexing assembly 52 as shown in FIG. 5 may be adhesively bonded to a face of the photo detector array 54. Optionally, any variety of techniques or devices may be used to affix the demultiplexing assembly 52 to the photo detector array 54, including, without limitations, mechanical coupling, fasteners, housings, soldering, brazing and the like. In some embodiments, the demultiplexing assembly 52 may be non-detachably coupled to the photo detector array 54. Optionally, the demultiplexing assembly 52 may be detachably coupled to the photo detector array 54.

The demultiplexing assembly 52 may also include an optically transparent detector window 122 (see FIG. 6), often made of fused silica or other material whose function is to hermetically seal the sensitive photo detector array 54. The detector window 122 may be disposed directly adjacent the input surfaces 116 of the detector elements 114 of the photo detector array 54, with the detector window 122 being configured to seal the input surfaces 116 of the detector elements 114 from contamination.

As discussed above, the photo detector array 54 may include detector elements 114 which may be configured to be electrically active or electrically inactive. An electrically active detector element 124 may have its electrical pin 118 electrically coupled to the analyzer 56, while an electrically inactive detector element 126 may have its electrical pin 118 electrically coupled to ground. The photo detector array 54 may include from about 10 to about 100 detector elements 114. The pattern of active/inactive detector elements 114 can be utilized in order to electrically isolate the optical channels 58 of the demultiplexing assembly 52. Inactive detector elements 126 of the photo detector array 54 may be permanently grounded so as to disable the detector element 126 and prevent electrical crosstalk between active portions of the photo detector array 54. Active detector elements 124 which are optically coupled to a respective optical channel 58 may be surrounded by inactive grounded detector elements 126 in order to electrically isolate the optical channel 58 from adjacent optical channels (see FIG. 15). FIG. 16 depicts a first optical channel 128 and a second optical channel 130 disposed adjacent to each other. An active first detector element 132 and an active second detector element 134 are configured to measure a filtered signal portion 47 which exits the output aperture 84 of the first optical channel 128. An inactive third detector element 136 is adjacent to the active second detector element 134. An active fourth detector element 138 and an active fifth detector element 140 are configured to measure optical signals transmitted through the second optical channel 130. If a portion of the filtered optical signal 47 transmitted through the first optical channel 128 strikes the inactive third detector element 136 or if an electrical signal generated by the active first detector element 132 or by the active second detector element 134 migrates to the third inactive detector element, any voltage present in the inactive third detector element 136 will be grounded and both the active fourth detector element 138 and the active fifth detector element 140 of the second optical channel 130 are unaffected by the filtered signal portion 47 or by the migrated electrical signal. Hence the first optical channel 128 is electrically isolated from the second optical channel 130 by the inactive third detector element 136. The active/inactive detector element pattern discussed above is two active detector elements 124 surrounded by single inactive detector elements 126, however any suitable pattern of active/inactive detector elements on the photo detector array 54 could be used. That is a single active detector element 124 may be surrounded by adjacent inactive detector elements 126, or a plurality of adjacent active detector elements 124 may be surrounded by a plurality of adjacent inactive detector elements 126. For some embodiments of the photo detector array 54, the active portions of the photo detector array 54 may be separated from adjacent active portions of the photo detector by a distance of less than about 1 mm.

The number of continuous or sequentially adjacent photo detector elements 114 for the photo detector array 54 may have any suitable number of detector elements 114. For example, some photo detector array 54 embodiments may have about 10 detector elements 114 to about 100 detector elements 114 or more, more specifically, about 20 detector elements 114 to about 50 detector elements 114, and even more specifically, about 30 detector elements 114 to about 40 detector elements 114. An example of such a linear photo detector array 54 is shown in FIG. 12. A suitable photo detector array may also include embodiments in which the detector elements are not configured as a linear array, but are instead configured as a two dimensional array, such as might be found in a charged couple device (CCD) chip embodiment. FIGS. 13 and 14 illustrate an embodiment of a CCD type chip detector array that has a plurality of detector elements 114 arranged in a two dimensional matrix. The pin configuration and electrical coupling of the CCD chip may be the same as or similar to that of the linear array.

For some embodiments of the photo detector arrays, the size of each detector element 114 may be small, for example, such detector elements 114 may have a transverse dimension of an input surface 116 of about 1 mm to about 4 mm. As such, an array suitable for a device having about 8 optical channels 58 to about 10 optical channels 58 may have about 35 such detector elements 114 disposed in a linear array with an overall length of less than about 3 inches, more specifically, less than about 2 inches. The detector elements 114 may be configured to detect light from optical signals and convert the incident light energy to electrical energy for a variety of wavelengths. In some cases, each detector element 114 may be configured to convert incident light energy into a voltage that is proportional to or otherwise dependent on an amplitude or intensity of light incident thereon. In general, some detector element 114 embodiments may be configured to detect and convert light having a wavelength of about 230 nm to about 4500 nm, more specifically, about 340 nm to about 1200 nm, as well as other wavelengths in some cases.

The photo detector array 54 may contain an array of detector elements 114 which are configured to convert the optical energy of each optical signal portion into electrical current which may then be translated to electrical pins 118 which may be suitably connected to corresponding detector elements 114. For some embodiments, the photo detector array 54 which is included in the demultiplexing assembly 52 may be of a length of about 50 mm, but can be essentially of any desired dimension depending upon the number of optical channels 58 required. A channel photocurrent for each of the optical channels 58 of the demultiplexing assembly 52 may be read off the electrical pins 118.

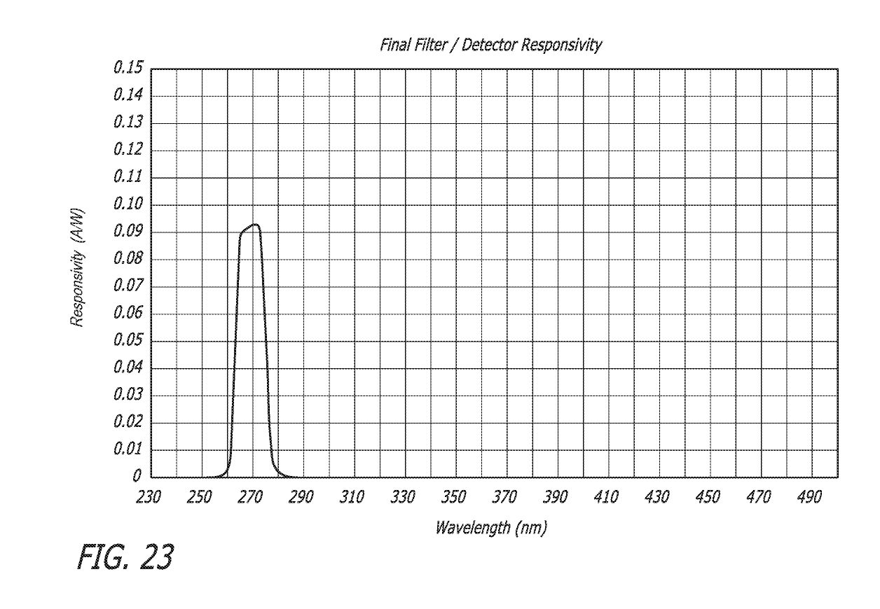

FIG. 23 shows graphically the net optical filter/detector responsivity A/W of an embodiment of a demultiplexing assembly 52 and photo detector array 54 at a typical UV range (230 nm-320 nm). More specifically, FIG. 23 shows the performance of an exemplary 270 nm all-dielectric filter when mated with a silicon carbide photodiode. At this wavelength, typical silicon carbide photodiodes may have a responsivity of about 0.1 A/W. As illustrated in FIG. 23, the net responsivity of this optical filter/detector combination may be about 0.09 A/W, almost an order of magnitude better than some MDM/silicon detector combination embodiments. In addition, unlike Si, SiC photo sensors are typically robust against ultraviolet light exposures, have improved field longevity and have long-term stability.

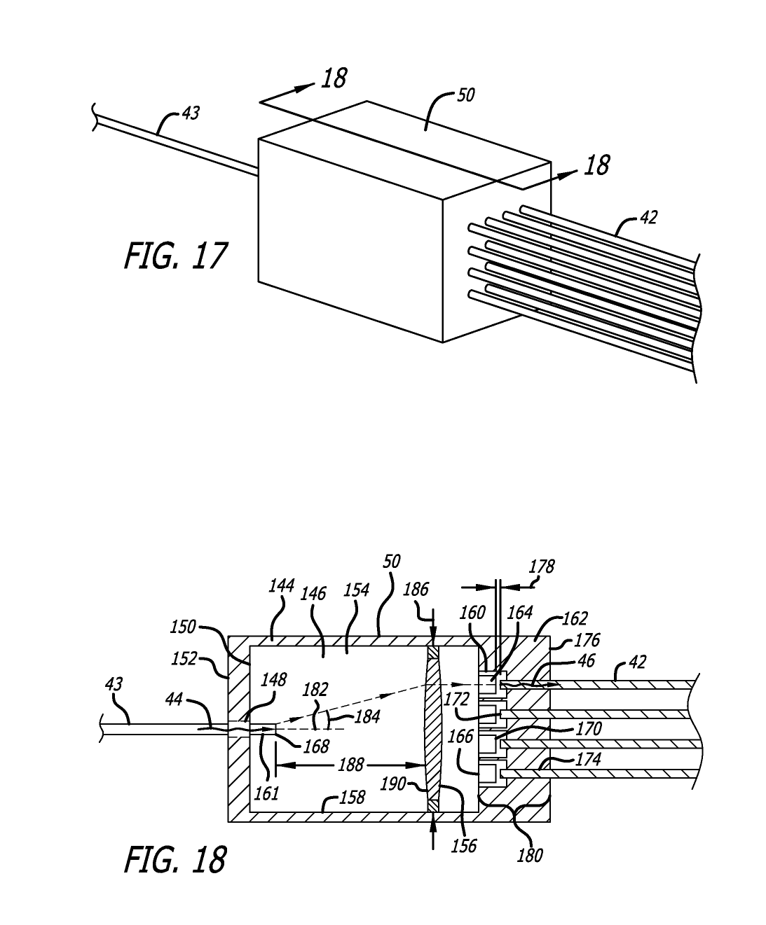

As discussed above, an input optical signal 44 which is to be analyzed by embodiments of the optical analysis system 40 may be split into multiple optical signal portions 46 prior to being analyzed by the demultiplexing assembly 52. FIG. 17 illustrates an embodiment of a multiplexer 50 wherein the input optical signal 44 may be propagated through the input multiplexer optical conduit 43 and is then split by the multiplexer 50 into multiple optical signal portions 46, with each optical signal portion 42 being propagated through a respective optical conduit 42 to the demultiplexing assembly 52 for analysis (as shown in FIG. 4). The multiplexer 50 may include a multiplexer housing 144 which may be fabricated from any suitable rigid material such as anodized aluminum or black delrin. The multiplexer 50 may include a lens cavity 146 which is disposed within the multiplexer housing 144 and an input conduit channel 148. The input conduit channel 148 may be disposed within an input portion 150 of the multiplexer housing 150, and the input conduit channel 148 may extend from a first outer surface 152 of the multiplexer housing to an interior volume 154 of the lens cavity 146. The input multiplexer optical conduit 43 may be rigidly secured to the input conduit channel 148 by an adhesive such as Epo-Tec OH105-2 or similar epoxy. The input multiplexer optical conduit 43 may be configured as an optical fiber. The optical fiber may be fabricated with any suitable core/cladding configurations and materials which have been previously discussed with regard to the optical conduit 42 embodiments.

The multiplexer may also include an optional collimating lens 156 which may be secured to a lens surface 158 of the lens cavity 146 by any suitable adhesive (not shown) such as Epo-Tec OH105-2 or similar epoxy. Alternatively, the collimating lens 156 may be secured to the lens cavity 146 by mechanical stops (not shown). The collimating lens 156 of the multiplexer 50 embodiments may have a focal length of about 2 mm to about 20 mm in some cases. The multiplexer 50 may also include an array of filter cavities 160 which are disposed within the multiplexer housing 144 such that they extend from the lens cavity 146 partially into an output section 162 of the multiplexer housing 144. Each filter cavity 160 may be configured to rigidly couple to a multiplexer bandpass filter 164. Each multiplexer bandpass filter 164 may be disposed within each filter cavity 160 such that an input surface 166 of each multiplexer bandpass filter 164 is directed toward an output surface 168 of the input multiplexer optical conduit 43, and an output surface 170 of each multiplexer bandpass filter 164 is directed toward an input surface 172 of a respective optical conduit 42 which may be suitably secured to the output section 162 of the multiplexer housing 144.

Each filter cavity 160 may also include an optical conduit channel 174 which may extend from the filter cavity 160 to an output surface 176 of the multiplexer housing 144. An optical conduit 42 may be secured to a respective optical conduit channel 174 by any suitable adhesive such as Epo-Tec OH105-2 or similar epoxy. The filter cavities 160 and the optical conduit channels 174 may be configured such that each multiplexer bandpass filter 164 disposed within its respective filter cavity 160 is in optical communication with each respective output conduit 42 which is disposed within its respective optical conduit channel 174. Each optical conduit 42 and each respective multiplexer bandpass filter 164 may disposed within the multiplexer housing 144 such that there is a gap 178 between the input surface 172 of the optical conduit 42 and the output surface 170 of the multiplexer bandpass filter 164. For some embodiments of the multiplexer 50, the gap 178 between the input surface 172 of each optical conduit 42 and the output surface 170 of each multiplexer bandpass filter 164 may be from about 1 mm to about 10 mm.

The multiplexer 50 embodiment which is depicted in FIGS. 17 and 18 shown with a single input multiplexer optical conduit 43, and with 16 multiplexer bandpass filters 164 and 16 respective optical conduits 42. The optical signal portions 46 which propagate within the 16 optical conduits 42 may be considered the optical outputs of the multiplexer 50, with each coupled multiplexer bandpass filter 164 and optical conduit 42 forming an optical channel 180 of the multiplexer 50. An output end 161 of the input multiplexer optical conduit 43 may be secured relative to the lens cavity of the multiplexer housing 144 such that an output surface 168 of the input multiplexer optical conduit 43 is directed toward and in optical communication with the input surfaces 172 of the optical conduits 42 of respective multiplexer output channels 180.

Each optical channel 180 of the multiplexer 50 may be optically coupled to a corresponding optical channel 58 of the demultiplexing assembly 52 by a respective optical conduit 42. Embodiments of the multiplexer 50 may also be configured with any number of coupled optical conduits 50 and multiplexer bandpass filters 164 which form the optical channels 180 of the multiplexer 50. For example, the multiplexer 50 may be configured with about 5 multiplexer bandpass filters 164 to about 20 multiplexer bandpass filters 164, and about 5 respective optical conduits 42 to about 20 respective optical conduits 42. As such about 5 to about 20 respective optical channels 180 of the multiplexer 50 may be formed. In this manner an input optical signal 44 which is transmitted through the multiplexer 50 would be transformed into a number of optical signal portions 46 that corresponds to the number of respective optical channels 180 of the multiplexer 50.

During use of the multiplexer 50, an input optical signal 44 may propagate within the input multiplexer optical conduit 43 and then exits an output surface 168 of the input multiplexer optical conduit 43 along a discharge axis 182 of the input multiplexer optical conduit 43 and into the lens cavity 146. The input optical signal 44 may diverge as it exits the input multiplexer optical conduit 43 along the discharge axis 182, with a divergence angle 184 of the input optical signal 44 being dependent upon the numerical aperture of the input multiplexer optical conduit 43. In some cases, the input optical signal 44 upon being emitted from the output surface 168 of the input multiplexer optical conduit 43 expands within a three dimensional volume thereby forming a solid angle, with the solid angle being defined by the divergence angle 184 of the input optical signal 44. For some embodiments of the multiplexer 50, the input optical signal 44 which is propagating within the solid angle which is emitted from the input multiplexer optical conduit 43 may overlap and encompass each input surface 166 of each multiplexer bandpass filter 164. For other embodiments of the multiplexer 50, the input optical signal 44 which is propagating within the solid angle which is emitted from the input multiplexer optical conduit 43 may overlap and encompass the input surface 190 of the collimating lens 158. The numerical aperture of the input multiplexer optical conduit 43 (which may determine the divergence angle 184), the diameter 186 and focal length of the collimating lens 156, and a distance 188 between the output surface 168 of the input multiplexer optical conduit 43 and an input surface 190 of the collimating lens 156 may all be configured such that the input optical signal 44 which exits the input multiplexer optical conduit 43 is entirely captured by the input surface 190 of the collimating lens 156 and distributed to all optical channels 180 of the multiplexer 150. As an example, the numerical aperture of the input multiplexer optical conduit 43 may be about 0.22 which gives a divergence angle of about 13 degrees as measured from the discharge axis 182 of the optical conduit 42. If the diameter 186 of the collimating lens 156 is about 8 mm, the focal length of the collimating lens 156 is about 17 mm, and the distance 188 between the output surface 168 of the input multiplexer optical conduit 43 and the input surface 190 of the collimating lens 156 is about 17 mm then all of the input optical signal 44 which exits the input multiplexer optical conduit 43 will be captured by the collimating lens 156. The input optical signal 44 may then pass through the collimating lens 156 resulting in substantial collimating of the input optical signal 44, and then pass through multiple multiplexer bandpass filters 164 with the output of each multiplexer bandpass filter 164 being an optical signal portion 46. Each optical signal portion 46 may then enter an input surface 172 of a respective optical conduit 42. Each multiplexer bandpass filter 164 may alter the spectral properties of the respective optical signal portion 46 which exits the respective multiplexer bandpass filter 164.

For some embodiments of the multiplexer 50, each multiplexer bandpass filter 164 may be configured to produce optical signal portions 43 with different spectral properties. In this case, each optical conduit 42 may carry an optical signal portion 43 with spectral properties which differ from the spectral properties of the optical signal portions 43 which are carried by the other optical conduits 42. Other multiplexer 50 embodiments may be configured such that each multiplexer bandpass filter 164 produces optical signal portions 143 with substantially the same or similar spectral properties. The multiplexer 50 may be configured with any suitable combination of multiplexer bandpass filters 164 which in turn may produce any suitable combination of optical signal portions 43 having similar or dissimilar spectral properties.

As discussed above, the multiplexer 50 embodiment which is shown in FIGS. 17 and 18 may include multiple multiplexer bandpass filters 164 which are optically coupled to respective optical output conduits 42 forming optical channels 180 of the multiplexer. Because each optical channel 180 has a respective multiplexer bandpass filter, each optical channel 180 can produce optical signal portions 43 which have different spectral bandwidths. In some cases (such as biomedical fluorescence applications or the like) it may be desirable for each optical channel of the multiplexer to produce optical signal portions which have the same spectral bandwidth output.

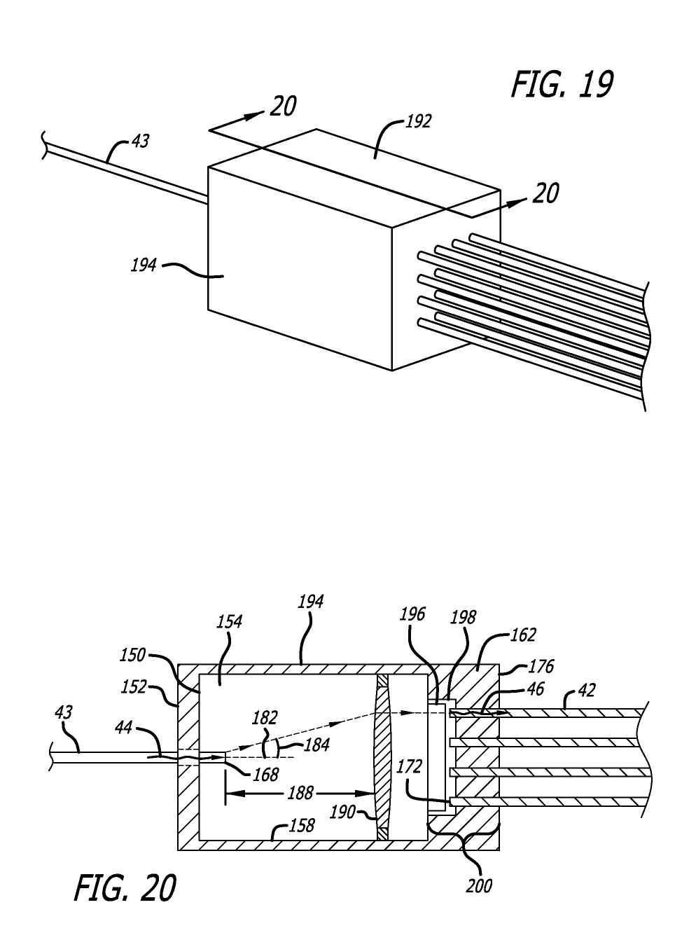

A multiplexer 192 embodiment which transforms an input optical signal into multiple optical signal portions 43 is shown in FIGS. 19 and 20. For some embodiments, the multiplexer 192 may be used in the place of multiplexer 50 for the optical analysis system 40 of FIG. 4. The multiplexer 192 may include a multiplexer housing 144, a lens cavity 146 disposed within the multiplexer housing 194, and a collimating lens 156 disposed within the lens cavity 146. The multiplexer 192 may also be secured to the input multiplexer optical conduit 43 which is secured to an input conduit channel 148, and multiple optical conduits 42 which are secured to respective optical conduit channels 174. The multiplexer 192 may also include a multiplexer bandpass filter 196 which is disposed within a filter cavity 198.

The multiplexer embodiment 192 shown in FIGS. 19 and 20 may be configured to function analogously to the multiplexer embodiment 50 of FIGS. 17 and 18 which was previously discussed. That is to say that all of the materials, manufacturing methods, dimensions, and functions of the multiplexer embodiment 50 which is shown in FIGS. 17 and 18 may be substantially similar to or the same as those of the multiplexer embodiment 192 which is shown in FIGS. 19 and 20 with the following exception. The multiplexer 192 of FIGS. 19 and 20 transforms a single input optical signal 44 into multiple optical signal portions 46 with substantially equivalent spectral bandwidth properties. This is because the multiplexer 192 is configured with a single multiplexer bandpass filter 196. Each optical conduit 42 which is secured to multiplexer 192 may be optically coupled to the multiplexer bandpass filter 196 thereby forming an optical channel 200. Each optical channel 200 of the multiplexer 192 may optically coupled to a corresponding optical channel 58 on the demultiplexing assembly 52. The multiplexer embodiment 192 could be configured with any number of optical conduits 42 which when optically coupled to the multiplexer bandpass filter 196 form the optical channels 200 of the multiplexer 192. For example, the multiplexer 192 may be configured with about 5 optical conduits 42 to about 20 optical conduits 42 each of which may be optically coupled to the multiplexer bandpass filter 196. As such about 5 to about 20 respective optical channels 200 of the multiplexer 192 may be formed.

For some indications (such as biofluorescence analysis) it may be desirable to analyze multiple input optical signals with each of the input optical signals having optical spectrum characteristics which are within the same wavelength bandwidth. An optical analysis system 202 which is configured to analyze multiple input optical signals 44 having similar optical spectrum characteristics is shown in FIG. 21. The optical analysis system 200 may include multiple optical conduits 42, a demultiplexing assembly 204 with photo detector array 54, and an analyzer 56. In some cases, the optical analysis system 204 may not include a multiplexer 50 (or multiplexer 192), as multiple input optical signals 44 are generated and it is not necessary to split any of the input optical signals 44 for analysis as with the optical analysis system 40 which is depicted in FIG. 4.

The optical conduits 42 and analyzer 56 may be configured analogously to the corresponding embodiments of the optical analysis system 40 which is depicted in FIG. 4 which has been previously discussed. That is to say that all of the materials, manufacturing methods, dimensions, and functions of the optical conduits 42 and analyzer 56 which are shown in FIG. 21 may be substantially similar to or the same as those of the corresponding embodiments shown in FIG. 4. The demultiplexing assembly 204 which is depicted in FIGS. 21 and 22 may be configured analogously to the demultiplexing assembly 52 depicted in FIGS. 4 and 5 with the following exception. The demultiplexing assembly 204 which is depicted in FIGS. 21 and 22 includes a single bandpass filter 206 while the demultiplexing assembly 52 depicted in FIGS. 4 and 5 includes multiple bandpass filters 60. Other than including the single bandpass filter 206, the demultiplexing assembly 204 which is depicted in FIG. 22 is configured analogously to the demultiplexing assembly 52 which is depicted in FIG. 5. That is to say that all of the materials, manufacturing methods, dimensions, and functions of the demultiplexing assembly 204 shown in FIG. 22 may be substantially similar to or the same as those of the demultiplexing assembly 52 which is shown in FIG. 5.

The demultiplexing assembly 204 which is depicted in FIG. 22 includes a single bandpass filter 206, and an optical channel of the demultiplexing assembly 204 may include the bandpass filter 206, an optical conduit 42, an optional collimating lens 62, and a channel cavity 210. In some cases, the bandpass filter 206 may be disposed outside of the channel cavity, between an output aperture 212 of the channel cavity and the photo detector array 54. The demultiplexing assembly 212 may be configured to prevent optical crosstalk and electrical crosstalk between the optical channels 208 of the demultiplexing assembly as has been previously discussed.

The demultiplexing assembly 206 depicted in FIGS. 21 and 22 includes 16 optical channels 208, however the demultiplexing assembly 204 may include any suitable number of optical channels 208. In use the demultiplexing assembly 204 would function as follows. Multiple input optical signals 44 from multiple samples 214 propagate within multiple respective optical conduits 42 to the demultiplexing assembly. The multiple input optical signals 44 may pass through optional collimating lenses 62. The multiple input optical signals 44 may then pass through the bandpass filter 206 which transforms the input optical signals 44 to filtered signal portions 47. The filtered signal portions 47 may then be measured and recorded by the photo detector array 54 and the analyzer 56 as has been previously discussed.

In this case, all of the filtered signal portions 47 pass through the bandpass filter 206, hence all of the filtered signal portions 47 have substantially the same spectral properties. The individual bandpass filters 60 of the demultiplexing assembly 40 of FIG. 5 are therefore replaced by one single bandpass filter 206 in the demultiplexing assembly embodiment 204 of FIG. 22. The single bandpass filter 206 may reside directly on the active surfaces of detector elements 114 of the photo detector array 54, or may be positioned as a window adjacent to the detector elements 114. All of the input optical signals 44 which are transmitted into the demultiplexing assembly 204 by the optical conduits 42 are transmitted through the single bandpass filter 206, and all of the input optical signals 44 exit the single bandpass filter as filtered signal portions 47 with substantially similar spectral characteristics. That is all of the optical signal portions 47 which exit the bandpass filter 206 have spectral characteristics that are within a similar wavelength bandwidth. The optical analysis system 202 which includes the demultiplexing assembly 204 having a single bandpass filter 206 may be useful for biological fluorescence analysis wherein it may be desired that each optical channel 208 analyze the same optical wavelength within the entire demultiplexing assembly 204; each optical channel 208 may be illuminated by optical signals coming from different biological samples for example. In some cases, the demultiplexing assembly 204 may optionally be used in place of the demultiplexing assembly 50 for the optical analysis system 40 depicted in FIG. 4. Additionally, the demultiplexing assembly 50 may optionally be used in place of the demultiplexing assembly 204 for the optical analysis system 202 depicted in FIG. 21.

With regard to the above detailed description, like reference numerals used therein may refer to like elements that may have the same or similar dimensions, materials and configurations. While particular forms of embodiments have been illustrated and described, it will be apparent that various modifications can be made without departing from the spirit and scope of the embodiments of the invention. Accordingly, it is not intended that the invention be limited by the forgoing detailed description.

The entirety of each patent, patent application, publication and document referenced herein is hereby incorporated by reference. Citation of the above patents, patent applications, publications and documents is not an admission that any of the foregoing is pertinent prior art, nor does it constitute any admission as to the contents or date of these documents.

Modifications may be made to the foregoing embodiments without departing from the basic aspects of the technology. Although the technology may have been described in substantial detail with reference to one or more specific embodiments, changes may be made to the embodiments specifically disclosed in this application, yet these modifications and improvements are within the scope and spirit of the technology. The technology illustratively described herein suitably may be practiced in the absence of any element(s) not specifically disclosed herein. Thus, for example, in each instance herein any of the terms “comprising,” “consisting essentially of,” and “consisting of” may be replaced with either of the other two terms. The terms and expressions which have been employed are used as terms of description and not of limitation, and use of such terms and expressions do not exclude any equivalents of the features shown and described or portions thereof, and various modifications are possible within the scope of the technology claimed. The term “a” or “an” may refer to one of or a plurality of the elements it modifies (e.g., “a reagent” can mean one or more reagents) unless it is contextually clear either one of the elements or more than one of the elements is described. Although the present technology has been specifically disclosed by representative embodiments and optional features, modification and variation of the concepts herein disclosed may be made, and such modifications and variations may be considered within the scope of this technology.

Certain embodiments of the technology are set forth in the claim(s) that follow(s).

What is claimed is:

1. An optical analysis system, comprising:
a photo detector array including a plurality of adjacent detector elements having coplanar input surfaces, active portions and inactive portions; and
a demultiplexing assembly comprising a plurality of optical channels, each optical channel including:
a channel cavity bounded by lateral baffles which are configured to optically isolate each channel cavity from all other channel cavities of said demultiplexing assembly, said channel cavity including an input end and an output end disposed opposite the input end and adjacent the photo detector array, the output end including an output aperture in optical communication with a respective active portion of the photo detector array,
a bandpass filter disposed within the channel cavity and including an input surface disposed towards the input end of the channel cavity and an output surface disposed towards the output end of the channel cavity; and
an optical conduit including an output end secured relative to the channel cavity such that an output surface of the optical conduit is directed toward and in optical communication with an input surface of the bandpass filter and the output aperture of the channel cavity.

2. The system of claim 1 wherein each channel cavity further comprises a support baffle which is disposed over at least part of the output surface of each respective band pass filter and with the output aperture of the channel cavity being formed in the support baffle.

3. The system of claim 1 wherein the optical conduit comprises an optical fiber.

4. The system of claim 3 wherein the optical fiber comprises a multimode optical fiber.

5. The system of claim 4 wherein the multimode optical fiber comprises an optical transmitting core including a transverse diameter of about 100 microns to about 1000 microns.

6. The system of claim 1 further comprising an optical conduit mounting block disposed at the input end of the channel cavities of the demultiplexing assembly and configured to secure the optical conduits in fixed relation to the channel cavities.

7. The system of claim 1 wherein the channel cavities and associated lateral baffles for each optical channel are formed from a unitary monolithic structure.

8. The system of claim 1 wherein the output end of each optical conduit extends into the input boundary of the input end of the channel cavity, the input boundary of the input end of the channel cavity being defined by a plane formed by the input edges of the lateral baffles at the input end of the channel cavity.

9. The system of claim 1 wherein the output end of each optical conduit extends within the input boundary of the input end of each respective channel cavity by a distance of about 0.5 mm to about 5 mm.

10. The system of claim 1 further comprising an analyzer operatively coupled to output interfaces of the photodetector array for each optical channel, said analyzer being configured to receive and store optical intensity data from active portions of the photo detector array.

11. The system of claim 1 wherein at least one detector element of each inactive portion of the photo detector array is permanently grounded so as to disable said detector element and prevent electrical crosstalk between active portions of the photo detector array.

12. The system of claim 1 further comprising an output interface of the photodetector array for each optical channel and wherein each output interface of the photo detector array comprises a pair of electrical pins.

13. The system of claim 1 wherein each optical channel further comprises at least one collimating lens which is disposed along a discharge axis of each optical conduit on the input side of the input surface of the respective bandpass filter.

14. The system of claim 1 further comprising a detector window which is disposed directly adjacent an input surface of the photo detector array, the detector window being configured to seal the input surfaces of the detector elements from contamination.

15. The system of claim 1 wherein each bandpass filter is configured to transmit a signal within a selected wavelength range.

16. The system of claim 1 further comprising a channel housing disposed about the channel cavities and associated baffle structures and seal the channel cavities from contamination.

17. The system of claim 1 wherein the detector elements of the photo detector array comprise a linear array of detector elements.

18. The system of claim 1 wherein each active portion of the photo detector array comprises a single detector element.

19. The system of claim 1 wherein each active portion of the photo detector array comprises a plurality of detector elements.

20. The system of claim 1 wherein the demultiplexing assembly has an overall length of less than about 3 inches.

21. The system of claim 20 wherein the demultiplexing assembly has an overall length of less than about 2 inches.

22. The system of claim 1 wherein the photo detector array comprises about 10 detector elements to about 100 detector elements.

23. The system of claim 1 wherein each active portion of the photo detector array is separated from adjacent active portions by a distance of less than about 1 mm.

24. The optical analysis system of claim 1 further comprising:
a multiplexer operatively coupled to the demultiplexing assembly, the multiplexer comprising:
a multiplexer housing including a lens cavity which is disposed within the multiplexer housing;
a plurality of multiplexer output channels in optical communication with optical conduits of respective optical channels of the demultiplexing assembly;
an input multiplexer optical conduit having an output end secured relative to the lens cavity of the multiplexer housing such that an output surface of the input multiplexer optical conduit is directed toward and in optical communication with input surfaces of the optical conduits of respective multiplexer output channels; and
a lens disposed within the lens cavity, the lens being configured to direct an optical output of the input multiplexer optical conduit to each multiplexer output channel.

25. The optical analysis system of claim 24 further comprising at least one multiplexer bandpass filter disposed within a filter cavity of the multiplexer housing, the at least one multiplexer bandpass filter having an output surface which is directed toward and in optical communication with an input surface of an optical conduit of a respective multiplexer output channel.
